(19) United States
(12) Patent Application Publication
(10) Pub. No.: US 2008/0025485 A1
(43) Pub. Date: Jan. 31, 2008

(54) Multi-network integration and interaction system

(76) Inventor: Duoyu Fan, Beijing (CN)

Correspondence Address: BIRCH STEWART KOLASCH & BIRCH, PO BOX 747, FALLS CHURCH, VA, 22040-0747, US

(21) Appl. No.: 11/601,742

(22) Filed: Nov. 20, 2006

(30) Foreign Application Priority Data
Jul. 31, 2006 (CN) 200610103698.5

(51) Int. Cl. H04M 11/00

(52) U.S. Cl. 379/93.09

(57) ABSTRACT

A type of multi-network integration and interaction system includes a “VLink” network server and a CTI communication controller, and the “VLink” network server and the CTI communication controller may communicate in real-time and two-way via Internet. The “VLink” network server notifies the CTI communication controller of the service request initiated by the client Internet terminal; it deals with the obtained telephone communication states and enables the client and the service provider to achieve multiple types of communications. And it judges the needed actions to be taken by the service provider based on the signals sent by the service provider's telephone terminal via CTI communication controller. The CTI communication controller initiates two callings on the traditional telephone network and connects the two callings; it detects the calling state and sends the information to the “VLink” network server; and transmits the signals sent by the service provider's telephone terminal to the “VLink” network server. This system realizes to initiate the communication link connection from Internet and enables one side of the communication to control the displayed contents on an Internet window of the other side by directly using the keyboard of the telephone.

### TECHNICAL FIELD

Multi-network integration and interaction (hereinafter referred as “VLink”) is a unique interaction technology. It connects Internet and the traditional telephone communication system through a special platform carried by the server and enables the client and the service provider to synchronously realize a real-time interaction via both the telecommunication links and the Internet links.

This invention relates to two fields of communication and Internet, especially a technology which converges the advantages of the two mentioned fields in real-time interaction.

### BACKGROUND ART

Firstly, two technologies related to the VLink technology are to be introduced:

1. The Telephone Callback Technology

Callback is a technology existing in the communication field. The principle is the following: At first, the traffic initiator (the client hereinafter) calls the access number of the callback platform. After receiving the calling number of the client, the platform initiatively hangs up the connection, and then calls back the client telephone as an operator within a preset period of time. After the client picks up the telephone, the first calling link is set up. The system plays the prompt voice, the client dials the called number (which the client wants to call), and the callback platform initiates a second call after receiving the called number, and plays the corresponding prompt voice for the client at the same time. If the recipient picks up the telephone, the second link is set up and synchronously the callback platform connects the two links, and the caller-to-recipient link is set up. The technology initiates two communication links of the two telephone numbers via the callback platform, when the two communication links are both connected, it connects the two links to enable an indirect real-time communication. The characteristic of callback technology lies in that it may realize the connection of the two originally non-directly connected communication points via a technology notion of back-to-back relay.

However, the callback technology can be initiated only via communication link, and it only can realize a voice communication between two communication points, but it can't realize other more complex types of interactions.

2. Instant Messaging (IM) Technology

IM is a technology to set up the point-to-point communication on inter-network, which sends and receives “messages” by UDP protocol. The client firstly acquires the friend's list from the server to create a point-to-point contact; the UDP format is applied to send information between the client (client1) and the friend (client2); the means of server relaying is used to achieve connection if it fails to contact directly point-to-point.

The IM technology completely relies on the Internet, and the quality of communications has an infinite relationship with the network situation between the two points. Furthermore, the communication of the two points becomes terribly difficult because of the protection for the private network in many private networks. At the same time, the IM requires client to download active-x plug ins or software, which results that the cost for the client to use the service is increased, and that the Internet security of the client is reduced. The more important is that the IM technology has totally nothing to do with the traditional telephone communication network. Therefore the possibilities for IM to be applied in large amounts of commercial applications is severely restricted. Simultaneously, since there is no multi-network integration realized, a client without Internet terminal could not utilize the advantage of the mass information of the Internet to show the information to those clients with Internet terminal by Internet.

The following is the interpretation of some terms appearing in this text:

CTI: the traditional CTI refers to the Computer Telephony Integration, which is referred as CT (Computer Telephony) abroad. The original purpose is to enable the computer to handle the telephone voice signal. Normally it needs some voice boards to provide hardware support. With the constant development of the computer network and telecommunication technology, the trend of constant integration and permeation are presented, wherein, the computer technology, typically the Internet, has accomplished a rapid development. And the telecommunication network has been developed into a communication network transmitting multi-media information on the basis of optic fiber and Asynchronous Transfer Mode (ATM) from the original simple telephone communication network, and at the same time the ability of providing extra-value -added services is enhanced. Nowadays, the “T” in “CTI” has been developed from the traditional “Telephony” to now “Telecommunication”, therefore, the CTI is defined as “Computer Telecommunication Integration”.

PSTN: the Public Switched Telephone Network is the public communication network with high popularization level and lowest cost at present and is also widely used in network. The applications of telephone networks have usually two types. One is that the connection between the organizations with the same level is realized in the form of the Dial On Demand Scheme (DDR), and the other is that the Internet service providers (ISP) provides the function of the remote access service for a client with dial-up access to the Internet.

DTMF: Dual-tone multi-frequency, DTMF for short, is a kind of client signaling between the telephone and exchange-board in the telephone system, usually used to send the called number. Before DTMF was used, in the telephone system, a series of discontinuous pulses was used to send the called number, which is called pulse dialing. Pulse dialing requires an operator to manually connect long distance calls. Now all the Interactive Voice Response (IVR) services obtain the selection and the response of clients via DTMF.

### DESCRIPTION OF THE INVENTION

This invention provides a multi-network integration and interaction system, which can initiate a similar communication link connection from the Internet and enables the two communication sides to complicatedly interact. It also enables one side of the interactive communication to directly use a communication device to control the displayed contents on Internet window of the other side.

The multi-network integration and interaction system of this invention includes the “VLink” network server and the CTI communication controller. The “VLink” network server and CTI communication controller take the real-time and two-way communication via Internet; after making a series of judgments on the service request sent via the Internet terminal from client, it notifies the CTI communication controller; By dealing with the states of the obtained telephone communication, it realizes the convergence of the traditional telephone communication and Internet communication; As a communication proxy server, it links the client and the service provider and realizes multiple typles of communications, either between the Internet terminal of the service provider and that of the client, or between the telephone terminal of the service provider and the Internet terminal of the client, in the latter case, the “VLink” network server judges the needed actions requested by the service provider based on messages sent by the telephone terminal of the service provider via the CTI communication controller, and transmits the action to the Internet terminal of the client. The CTI communication controller, according to the calling requests sent from the “VLink” network server, initiates two callings of traditional telephone network and connects the two callings; It detects the state of the calling and sends the state to the “VLink” network server. It transmits the signals sent by the telephone terminal of the service provider to the “VLink” network server.

The multi-network integration and interaction system also includes a calling proxy, which receives the calling requests from the “VLink” network server and sends them to the CTI communication controller.

The multi-network integration and interaction system also includes a calling status controller, which acquires the calling states from the CTI communication controller and sends them to the “VLink” network server.

The multi-network integration and interaction system also includes a client manager, which is the client management part of the entire system. Via the client manager, the client of service provider and the serviced client could inquire their own information, log on or quit the network, and via it the service provider can also charges his account.

The multi-network integration and interaction system also includes a client's terminal module and a service provider's module. The client's terminal module is the displayed part of Internet accessed after the client clicks the propaganda of service provider and initiates a service request and this part displays the contents designated by the service provider. The client initiates another service request via this module and submits other information. The service provider's module is the module logged on when the service provider can access into Internet and interacts with the client. The service staff of the service provider sends the information to the serviced client via this module when the telephone of the client and the telephone logged on of the service staff are connected by the CTI communications controller.

Comparing with the callback technology, “VLink” realizes a similar communications link connection initiated from Internet and at the same time enables the two communication sides to use more complicated interaction types. These types include, but not limited to communications of texts, communications of pictures and communications of video, etc. Furthermore, one side of the interaction can also control the displayed contents on the others' Internet link directly via the keyboard of the telephone. Thus, “VLink” technology greatly exceeds the callback technology in aspects of solution, function and applications fields.

Comparing with the IM technology, “VLink” is not necessary to download any software or active-x plug-ins. The client can use it wherever it is available. It enables one of the communicating sides to directly utilize communication equipment to control the displayed content on the others' Internet window.

This invention can also identify the two communicating sides without connecting the Internet and the communication link. It can detect the states of the two connected sides and enables the two sides to realize the interaction on Internet when the communication links are connected; and provides powerful functions to avoid malicious callings for the service providers.

Furthermore, “VLink” technology has the following beneficial effects:

1. To Promote the Development of E-Commerce

The merchant expects to communicate more with clients and is ready to pay for related costs; the technology can put voice into the communication process of the Internet, which may effectively improve the trust between the client and the service provider and improve the deal rate. At the same time, it provides the service provider with much more economical and effective means to communicate with the clients. It even reduces the communications cost of the client, and saves time for the client. It also has a various types of interactive communications and a mass of information capacity.

2. To Promote the Innovation of the Marketing and Sales and Improve the Vitality of the Market Economy

For the enterprises in the market economy, how to transform the potential client into ral client and accomplish the sale rapidly through market manner is the essential part for the marketing of most enterprises.

This technology provides an unprecedented approach for the enterprises in the above aspect and helps them to make direct and interactive communication with the clients more quickly when releasing advertisements. It has creative styles and also resolves the inherent problem of the indirect effect of advertising.

3. While Creating New Marketing Modes, the Intrinsic Investment of the Enterprise is Ensured Without Ruining the Existing Technology Situation

This technology creates new marketing modes, and simultaneously will not ruin the existing technology situation and adopts the means fitting for the current using habit of the public. In this way, the intrinsic market investment of enterprise is well ensured. And the added value that enterprises acquired will not conflict with its intrinsic value through adopting this technology.

4. To Promote the Development of Other Marketing Modes

As above, this technology will not ruin the existing technology situation while provides a brand new added value based on this. Thus, with the added value increased successively, the enterprise will adopt the intrinsic marketing mode much more as an assistant measure to achieve the application of this technology. In other words, this technology will objectively promote the further development of other marketing modes.

### BRIEF DESCRIPTION OF THE DRAWINGS

This invention will be further described in conjunction with the attached drawings, in which:

FIG. 1 shows the systematic principle of the invention;

FIG. 2 shows the systematic framework of the invention;

FIG. 3 shows the flowchart actually used by the client.

### BEST MODE FOR CARRYING OUT THE INVENTION

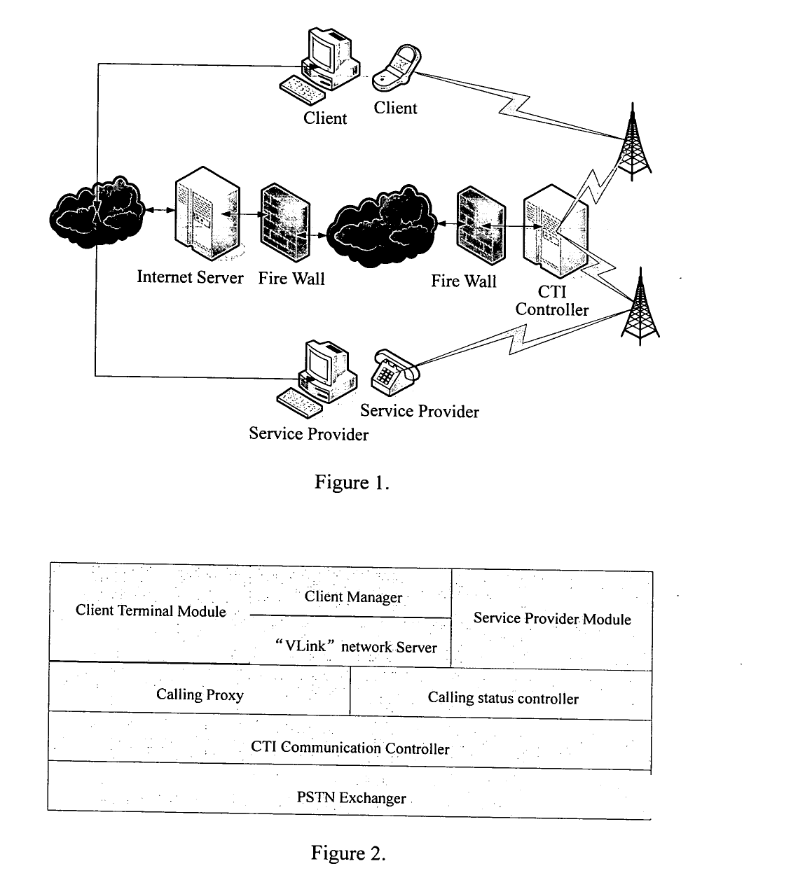

Referring to the FIG. 1, the multi-network integration and interaction of this invention includes a CTI□ Computer Telecommunication Integration□ communication controller and an Internet services server. When a service request is initiated by a client and consequently the service is provided by the service provider, it also includes a client telephone terminal equipment and an Internet terminal equipment, a service provider's communication terminal equipment and an Internet terminal equipment.

Usually, the client initiates the service request via his own Internet terminal, and this service request is transmitted to the Internet traffic server via the Internet. After making a series of judgments on the request, the Internet traffic server informs the CTI communication controller via the Internet and asks the CTI communications controller to simultaneously connect the telephones of the client and the telephones of the service provider, thus enabling the two sides to communicate. Therefore, the client's telephone terminal and the service provider's telephone terminal can get into voice communication via the traditional public telephone network.

At the same time, as a communication proxy server, the Internet service server will connect the Internet terminal equipment of the client and that of the service provider to conduct the communication of the texts, pictures, voice and video. This kind of communication can be displayed on the client Internet terminal transmitted either from the Internet service server or from the service provider's Internet terminal [based on the specific service modes].

Because of the real-time and two-way communication between the Internet service server and the CTI communication controller via Internet, the content displayed on the screen of client's Internet terminal being controlled via telephone terminal keys of the service provider can be ensured.

Finally, the simultaneous communication and convergence of the Internet and telephone of the client and service provider is realized.

The “VLink” technology is adopted by the following step.

1. Triggering the Connection of the Communication Links via the Internet

Firstly, the “VLink” system creates an input window in Internet, which communicates with the “VLink” network server (by means of Flash or JavaScript), and combines the window with one or more service provider's telephone number.

When logging onto the Internet, as long as the client inputs the client's telephone number in the input window and click enter, the telephone number will soon be transmitted to the “VLink” network server. The “VLink” network server simultaneously initiates the two communication links of the telephone number and the combined service provider's number via CIT communication controller. When the two communication links are all connected, the two links are joined. Thereby the real-time and indirect connection of the client and the service provider is formed.

2. Realizing the Internet Links Interaction, Which is Synchronous With the Telecommunication Link, by the Unique IDs of the Two Communication Sides.

When setting up the real-time client-to-service-provider connection, an Internet action is simultaneously triggered on the client's terminal and accordingly an Internet page provided by the “VLink” network server is opened.

In the previous step 1, the server keeps the client's ID who initiated the communication and by using this ID, automatically detects the real-time status (not in communication, in communication, end of communication) of the two communication sides, and can acquire the positions of the two sides in communication.

When this status is “in communication”, the service provider can send the keyboard signals to the “VLink” network server via CTI communication controller by pressing the keys on the local communication equipment. The “VLink” network server judges the action requested by the service provider according to the signals, and sends this action to the client's Internet terminal.

When the page of the client's Internet terminal receives the instructions from the “VLink” network server, i.e. according to the instructions, finally the real-time updates on webpage are realized.

3. To Realize the Interaction of the Links Between the Internets via the Unique IDs of the Two Communicating Sides.

When the client and the service provider all have the Internet equipment, the unique communication ID initiated by the communication link can also directly define the Internet connection of the two communicating sides. At this moment, it implies that the client needn't initiatively show his ID, the service provider can realize the direct interaction with the client directly through the Internet link.

Referring to FIG. 2, the system integral framework of this invention includes:

1. The Client's Terminal Module

The client's terminal module is the Internet displayed part accessed by the client after initiating a service request by clicking on the advertisements of the service provider. This part includes the function of displaying the designated content by the service provider, the function of initiating another service request and the function of the client to submit other information.

This module can be realized by HTML, or by downloading browser controls, or by downloading software, or also by the third party's manner like Flash, etc.

2. The Service Provider's Module

The service provider's module is a module, which can be logged onto when the service provider can access into the Internet to interact with client. The service staff of the service provider can log onto the module when in service. And the service staff may send information (including but not limited to Internet pages, pictures, animations and videos) to the client via this module when the telephone of the client and the telephone of service staff are connected by the CTI communication controller.

This module can be realized by HTML, or by downloading browser controls, or by downloading software, or also by the third party's manner like Flash, etc.

3. The Client Manager

The client manager is the client management part of the entire system. The client of the service provider and the serviced client inquire their information, log on or quit the network via this module. The service provider can also takes the operation of charging his account and so on via this module.

It is the server terminal program and can be realized with any program language of the server terminal.

4. The “VLink” Network Server

The “VLink” network server is in charge of communication with the calling proxy and the calling status controller, and realizes the traditional telephone communication initiated via the Internet and simultaneously deals with the telephone communication status obtained from the calling status controller. It is the key module to converge the traditional telephone communication and Internet communication.

It is the server terminal program and can be realized with any program language of the server terminal.

5. The Calling Proxy

The calling proxy is responsible to receive the calling requests from the “VLink” network server and forward them to the CTI communications controller.

It is the server terminal program and can be realized with any program language of the server terminal.

6. The Calling Status Controller

The calling status controller is responsible to acquire calling status from the CTI communication controller and send them to the “VLink” network server.

It is the server terminal program and can be realized with any program language of the server terminal.

7. The CTI Communication Controller

The CTI communication controller is the core parts to accomplish the traditional telephone communication, which, according to the calling requests sent by the calling proxy, initiates two callings on the traditional telephone network and connects them. Simultaneously, it detects the calling status and sends them to the calling status controller.

It is the server terminal program and can be realized with any program language of the server terminal.

8. PSTN Exchanger, Namely, the Traditional Exchanger

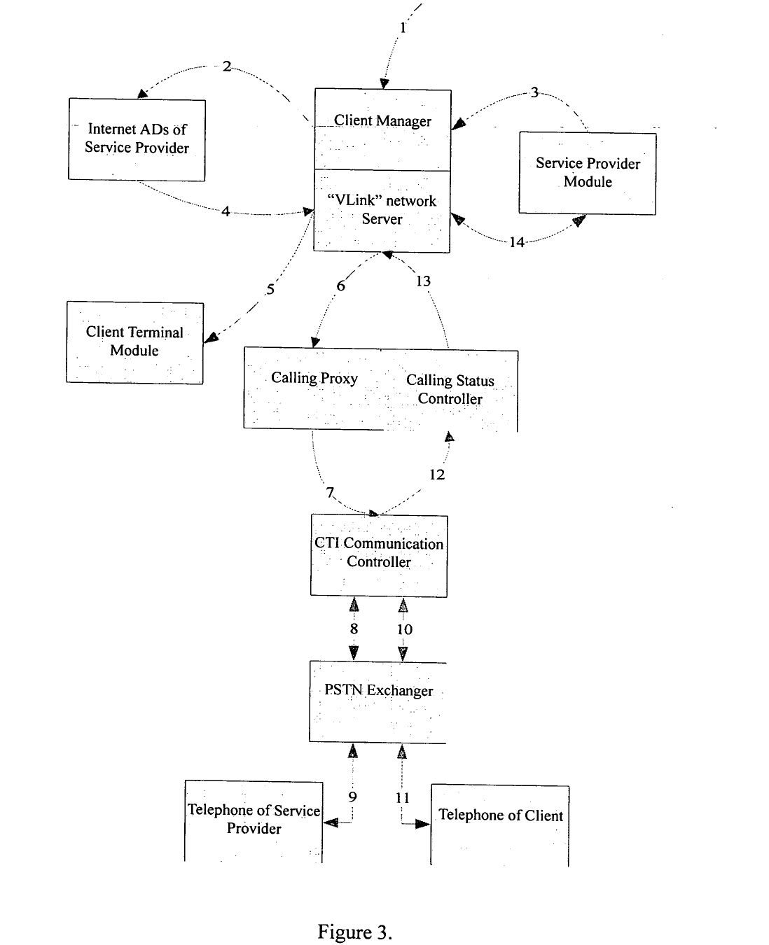

Referring to FIG. 3, the system of the invention takes the following steps in the actual application:
1. The service provider makes a registration, and a telephone number available to clients and other related information must be provided and be stored into the client manager.
2. The service provider propagandizes the services on the Internet, and the links of the propaganda point to the “VLink” network server.
3. The service staff of the service provider can log on via the “VLink” network server to access into the module of the service provider, which provides functions of client management, historical list and Internet communication with the client on line, etc. It can also control the displayed contents of the client's Internet via this module when communicating with the client by telephone.
4. The client clicks on Internet advertisements provided by the service provider.
5. To access the client terminal module provided by the “VLink” network server.
6. The “VLink” network server finds out the appropriate enterprise number from the Internet server database and sends the client number, the enterprise number and other related parameters to the calling proxy.
7. The calling proxy sends a calling request to the CTI communication controller and generates and records the serial number.
8. And 9. The CTI communication controller calls the service provider's registered telephone via the traditional PSTN exchanger.
10. And 11. The CTI communication controller calls the client's telephone via the traditional PSTN exchanger, and connects the two calls if they are all connected.
12. The CTI communication controller will intercept and capture the DTMF signals of the service provider's telephone keying and send them to the calling status controller.
13. The calling status controller, according to the calling status signals, notifies the client module to display specified contents (including but not limited to Internet pages, pictures, animations and videos) via the “VLink” network server, and thus achieves the purpose of controlling the displayed contents on the client's Internet terminal.
14. The staff of the service provider who has logged onto the service provider's module can also utilize the service provider's module to control the displayed contents on the client Internet terminal via the “VLink” network server.

The above interpretation is only one embodiment in accordance with the invention. The equivalent replacement or simple improvements conducted by the person skilled in this field based on the principle of this invention should also be included in the scope of the claims. For instance, it is easy to understand that the service provider mentioned in the above interpretation may also be another client different from the mentioned client, and in this case this invention is still applicable.

1. A kind of multi-network integration and interaction system, including:
a “VLink” network server, which communicates in real time and in two ways with a CTI communication controller via the Internet; after making a series of judgments on the service request sent from the client via his Internet terminal, which notifies the CTI communication controller via Internet; which deals with the state of the obtained telephone communication so as to realize the combination of the traditional telephone communication and Internet communication; as a communication proxy server, which enables the client and the service provider to communicate or the client and the client to communicate to realize multiple types of communications either between two Internet terminals, or between a telephone terminal and an Internet terminal, in the latter case, the “VLink” network server judges the needed actions requested by the service provider based on messages sent by a telephone terminal via the CTI communication controller, and transmits the action to the other Internet terminal; and
a CTI communication controller, which, according to the calling requests sent from the “VLink” network server, initiates two callings of traditional telephone network and connects the two callings; which detects the state of the calling and sends the state to the “VLink” network server; and which transmits the signals sent by any side of the telephone terminals to the “VLink” network server.

2. The multi-network integration and interaction system according to claim 1, wherein, further including a calling proxy, which receives the calling requests from the “VLink” network server and sends them to the CTI communication controller.

3. The multi-network integration and interaction system according to claim 1 or 2, wherein, further including a calling status controller, which acquires the calling states from the CTI communication controller and sends them to the “VLink” network server.

4. The multi-network integration and interaction system according to claim 1 or 2, wherein, further including a client manager, which is the client management part of the entire system, and via which the service provider and the serviced client inquire their own information, log on or quit the network, and via which the service provider can also charges his account.

5. The multi-network integration and interaction system according to claim 3, wherein, further including a client manager, which is the client management part of the entire system, and via which the service provider and the serviced client inquire their own information, log on or quit the network, and via which the service provider can also charges his account.

6. The multi-network integration and interaction system according to claim 1, wherein, further including:
a client's terminal module: which is the displayed part of Internet accessed after the client clicks the propaganda of the service provider and initiates a service request, this part displays the contents designated by the service provider, and the client initiates another service request via this module and submits other information; and
a service provider's module: which is the module he could log on when he has internet access and interacts with the client, and the service staff of the service provider sends information to the serviced client via this module when both telephones of the client and the service staff are connected by the CTI communications controller.
